(19) United States
(12) Patent Application Publication
(10) Pub. No.: US 2009/0168704 A1
(43) Pub. Date: Jul. 2, 2009

(54) METHOD OF TRANSMITTING CONTROL INFORMATION FOR SCHEDULING

(76) Inventors: Young Dae Lee, Gyeonggi-do (KR); Sung Duck Chun, Gyeonggi-do (KR); Myung Cheul Jung, Seoul (KR); Sung Jun Park, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/064,322

(22) PCT Filed: Aug. 23, 2006
(86) PCT No.: PCT/KR2006/003314

§ 371 Date: Aug. 1, 2008

(30) Foreign Application Priority Data
Aug. 24, 2005 (KR) 10-2005-0078066

(51) Int. Cl. H04W 72/12

(52) U.S. Cl. 370/329

(57) ABSTRACT

A method of transmitting control information for scheduling is disclosed, by which scheduling information can be efficiently transmitted to a Node B. The present invention comprises the steps of filling a first data unit with at least one second data unit transmitted from an upper layer, and providing the first data unit including the at least one second data unit(s) and the uplink information for the scheduling control if the first data unit has the room for adding the uplink information for the scheduling control.

### TECHNICAL FIELD

The present invention relates to in a radio communication system, more particularly to a method of transmitting control information for scheduling in a mobile communication system.

### BACKGROUND ART

FIG. 1 is a block diagram of a network structure of UMTS (universal mobile telecommunications system) of the 3GPP asynchronous IMT-2000 system.

Referring to FIG. 1, a universal mobile telecommunications system hereinafter abbreviated UMTS) mainly includes a user equipment (hereinafter abbreviated UE), a UMTS terrestrial radio access network (hereinafter abbreviated UTRAN), and a core network (hereinafter abbreviated CN).

The UTRAN includes at least one radio network sub-system (hereinafter abbreviated RNS). And, the RNS includes one radio network controller hereinafter abbreviated RNC) and at least one base station (hereinafter called Node B) managed by the RNC. And, at least one or more cells exist in one Node B.

FIG. 2 is an architectural diagram of a radio interface protocol between a UE (user equipment) and a UTRAN (UMTS terrestrial radio access network) based on the 3GPP radio access network standard.

Referring to FIG. 2, a radio interface protocol vertically includes a physical layer, a data link layer, and a network layer and horizontally includes a user plane for data information transfer and a control plane for signaling transfer.

The protocol layers in FIG. 2 can be divided into L1 (first layer), L2 (second layer), and L3 (third layer) based on three lower layers of the open system interconnection (OSI) standard model widely known in the communications systems.

First of all, the physical layer (hereinafter named PHY) as the first layer offers an information transfer service to an upper layer through a physical channel. The physical layer PHY is connected to a medium access control (hereinafter abbreviated MAC) layer above the physical layer PHY via a transport channel. And, data are transferred between the medium access control layer MAC and the physical layer PHY via the transport channel. Moreover, data are transferred between different physical layers, and more particularly, between one physical layer of a transmitting side and the other physical layer of a receiving side via the physical channel.

The medium access control (hereinafter abbreviated MAC) layer of the second layer offers a service to a radio link control layer above the MAC layer via a logical channel.

The MAC layer can be divided into various kinds of sublayers including a MAC-d sublayer, a MAC-e sublayer and the like according to a type of a managed transport channel.

FIG. 3 is a diagram of a structural example of a protocol for DCH and E-DCH.

Referring to FIG. 3, both DCH and E-DCH are transport channels that can be dedicatedly used by one user equipment.

In particular, the E-DCH is used for a user equipment to transfer data to a UTRAN in uplink. Compared to the DCH, the E-DCH can transfer uplink data faster than the DCH. To transfer data at high speed, the E-DCH adopts such a technique as a hybrid automatic repeat request (hereinafter abbreviated HARQ) scheme, an adaptive modulation and coding (hereinafter abbreviated AMC) scheme, and a Node B controlled scheduling scheme and the like.

For E-DCH, Node B transfers downlink control information for controlling a UE's E-DCH transfer to the UE. The downlink control information includes response information (ACK/NACK) for HARQ, channel quality information for AMC, E-DCH transport rate assignment information for Node B controlled scheduling, E-DCH transport start time and transport time interval assignment information, transport block size information, etc. Meanwhile, the UE transfers uplink control information to the Node B. The uplink control information includes E-DCH rate request information for Node B controlled scheduling, UE buffer status information, UE power status information, etc.

A MAC-d flow is defined between MAC-d and MAC-e for E-DCH. In this case, a dedicated logical channel is mapped to the MAC-d flow, the MAC-d flow is mapped to a transport channel E-DCH, and the E-DCH is mapped to another physical channel E-DPDCH (enhanced dedicated physical data channel).

The MAC-d sublayer is responsible for managing the DCH (dedicated channel) as a dedicated transport channel for a specific user equipment, while the MAC-e/MAC-es sublayer manages the E-DCH (enhanced dedicated channel) as a transport channel used in transferring fast data in uplink.

A transmitting side MAC-d sublayer configures a MAC-d protocol data unit (hereinafter abbreviated PDU) from a MAC-d service data unit (hereinafter abbreviated SDU) delivered from an upper layer, i.e., an RLC layer. And, a receiving side MAC-d sublayer plays a role in recovering MAC-d SDU from MAC-d PDU received from a lower layer and delivering the recovered MAC-d SDU to an upper layer. In doing so, the MAC-d exchanges MAC-d PDU with a MAC-e sublayer via MAC-d flow or exchange MAC-d PDU with a physical layer via DCH. The receiving side MAC-d sublayer recovers MAC-d PDU using a MAC-d header attached to the MAC-d PDU and then delivers the recovered MAC-d SDU to an upper layer.

A transmitting side MAC-e/MAC-es sublayer configures MAC-e PDU from MAC-d PDUs delivered from the MAC-d sublayer, i.e., MAC-e SDU. And, a receiving side MAC-e sublayer plays a role in recovering MAC-es PDU from MAC-e PDU received from a lower layer, i.e., a physical layer. And, a receiving side MAC-es sublayer plays a role in recovering MAC-d PDUs from the MAC-es PDU and delivering the recovered MAC-d PDUs to the MAC-e. In doing so, the MAC-e exchanges MAC-e PDU with the physical layer via E-DCH.

The MAC-e sublayer supporting E-DCH, as shown in FIG. 3, exists below a MAC-d sublayer of a UTRAN. And, a MAC-e sublayer supporting E-DCH exists below a MAC-d sublayer of a UE as well.

The MAC-e sublayer of the UTRAN is located at a Node B. And, the MAC-e sublayer exists in each UE as well. On the other hand, the MAC-d sublayer of the UTRAN is located at an SRNC taking charge of a management of a corresponding UE and the MAC-d sublayer exists in each UE as well.

E-DPDCH and E-DPCCH exist as physical channels of E-DCH. User data or signaling information between MAC entities is substantially transmitted on E-DPDCH. And, E-DPCCH is a channel that carries control information for E-DPDCH and is able to indicate a size of MAC-e PDU transmitted on E-DPDCH, an order of HARQ retransmission information and a portion of E-DPDCH transmitted on E-DPDCH as a coding result of MAC-e PDU.

Control information transmission in E-DCH is explained as follows.

First of all, SRNC sets TTI (transmission timer interval) to be used by a UE in E-DCH to 2 ms or 10 ms via a downlink control signal.

If the UE is set to 2 ms, one UE uses maximum eight processes. If the UE is set to 10 ms, one UE uses four processes.

And, one process performs one HARQ operational process.

In particular, in case of 2 ms, a UE is able to have maximum eight processes. Each of the eight processes individually performs a HARQ operation. In case of 10 ms, a UE has four processes. And, each of the four processes individually performs a HARQ operation.

In this case, in case of operating by 2 ms, the UE does not use eight processes all the time. In particular, the Node B and RNC inform the UE of information indicating how many processes will be used and which one of eight processes will be selectively used. Specifically, the Node B activates or inactivates specific processes in addition according to a status of a cell managed by the Node B itself among the processes activated by the RNC. For this, the Node B uses AG (absolute grant). In the inactive process, the UE is unable to transmit user data.

An identifier for E-DCH is allocated to a UE by an SRNC. The identifier is divided into a primary identifier and a secondary identifier. One primary identifier is allocated to one UE and one secondary identifier is allocated to at least one or more UEs.

As an example of the primary identifier, there is a primary E-RNTI. As an example of the secondary identifier, there is a secondary E-RNTI.

The UE is able to have either the primary E-RNTI or the secondary E-RNTI only according to a setup of the SRNC. And, the UE is also able to have both of the primary and secondary E-RNTIs.

A scheduler is able to adjust a quantity of radio resource allocation to a specific UE via the primary E-RNTI. Since a requirement of one UE can be suitably accepted, it is enough to get closer to the requirement of the UE.

Yet, via the secondary E-RNTI, a quantity of radio resource allocation is adjusted by grouping at least one or more UEs. In this case, it is unable to meet the requirements of the respective UEs. Yet, if a cell load is raised, it facilitates the cell load to be adjusted without transmitting downlink signals to the UEs, respectively.

If a radio resource needs to allocated by grouping UEs, a scheduler transmits a radio resource allocation quantity to the UEs using a secondary E-RNTI.

If a primary E-RNTI is allocated to a UE only, the corresponding UE operates with the primary E-RNTI only. In this case, since one UE uses the primary E-RNTI in one cell, a Node B adjusts the radio resource allocation quantity usable by the UE in a manner of transmitting information indicating an allocation of a radio resource such as a transmission AG (absolute grant) or RG (relative grant) corresponding to the UE only. In this case, the information sent by the Node B to the UE to indicate the allocation of the radio resource includes the primary E-RNTI and the information indicating the allocation of the radio resource is used by the UE having the primary E-RNTI only.

If a secondary E-RNTI is allocated to a UE, the corresponding UE operates with the secondary E-RNTI. In this case, since at least one or more UEs operate with the secondary E-RNTI in one cell, a Node B adjusts the radio resource allocation quantity usable by the UEs operating with the secondary E-RNTI in a manner of transmitting information indicating an allocation of a radio resource such as a transmission AG (absolute grant) or RG (relative grant) corresponding in common to the UEs. In this case, the information sent by the Node B to the UEs to indicate the allocation of the radio resource includes the secondary E-RNTI and the information indicating the allocation of the radio resource is just used by the UEs having the secondary E-RNTI to operate with the secondary E-RNTI.

If both primary R-RNTI and secondary E-RNTI are allocated to a UE, the corresponding UE operates with either the primary E-RNTI or the secondary E-RNTI according to a command of a Node B. In this case, a fact that the UE operates with the primary E-RNTI means that the UE operates as if the primary E-RNTI is allocated thereto only. And, a fact that the UE operates with the secondary E-RNTI means that the UE operates as if the secondary E-RNTI is allocated thereto only.

Meanwhile, a scheduler of a Node B transmits Primary Absolute Grant to UEs operating with primary E-RNTI using the primary E-RNTI. And, a scheduler of a Node B transmits Secondary Absolute Grant to UEs operating with secondary E-RNTI using the secondary E-RNTI. In this case, in case of operating with the primary E-RNTI, once receiving AG or RG corresponding to its primary E-RNTI, the UE sets its radio resource allocation quantity according to a value of the received AG or RG. In case of operating with the secondary E-RNTI, once receiving AG or RG corresponding to its secondary E-RNTI, the UE sets its radio resource allocation quantity according to a value of the received AG or RG.

A field of AG is constructed with two parts. One part is a field indicating a radio resource allocation quantity associated with availability for maximum power to be used by a UE. And, the other part is a field indicates a prescribed process of the UE for which the radio resource allocation quantity will be substantially set. This field indicates whether the radio resource allocation quantity corresponds to one process or all processes.

A UE, to which both primary E-RNTI and secondary E-RNTI are allocated, operates in the following manner.

First of all, in case of receiving AG (absolute grant) corresponding to its primary E-RNTI, the UE operates with the primary E-RNTI and sets a radio resource allocation quantity to a value included in the AG. In case of receiving AG corresponding to secondary E-RNTI, the UE updates internally stored secondary AG into a value of the received AG.

The UE keeps operating with the primary E-RNTI until being instructed that the AG value becomes zero that corresponds to all processes. The UE then operates with the secondary E-RNTI. And, the UE sets an initial value of its radio resource allocation quantity to the stored secondary AG value. While operating with the secondary E-RNTI, in case of receiving AG corresponding to its secondary E-RNTI, the UE updates its radio resource allocation quantity into a received value.

In the related art E-DCH transmission, a UE transmits radio source allocation request control information to a Node B each time a prescribed condition set by an ENC or the Node B is met, without considering that it operates according to the secondary E-RNTI or the primary E-RNTI.

Substantially, in case that a UE is operating with secondary E-RNTI, there exist at least one or more UEs operating with the secondary E-RNTI in a specific cell. In this case, a scheduler of a Node B transmits radio resource allocation information to a plurality of UEs bound into one group by considering various situations including a cell load and the like.

Hence, the Node B sends radio resource allocation information enough to satisfy most of the UEs corresponding to the secondary E-RNTI in common on the whole instead of sending radio resource allocation information adjusted suitable for a situation of each of the UEs operating with the secondary E-RNTI.

However, despite receiving radio resource allocation request control information from UEs corresponding to secondary E-RNTI respectively, a Nod B is unable to accurately meet a request of each of the UEs. In particular, even if a UE sends radio resource allocation request control information, a Node B doest not use the received information entirely. So, if a UE operating with secondary E-RNTI transmits radio resource allocation request information each time like the case of operating with primary E-RNTI, this generates an uplink signal unnecessarily to raise a cell load in the end.

### DISCLOSURE OF THE INVENTION

Accordingly, the present invention is directed to a method of transmitting control information for scheduling that substantially obviates one or more of the problems due to limitations and disadvantages of the related art.

An object of the present invention is to provide a method of transmitting control information for scheduling, by which radio resource allocation request control information can be efficiently transmitted to a Node B.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of transmitting control information for scheduling in a communication system according to the present invention comprises the steps of filling a first data unit with at least one second data unit transmitted from an upper layer, and providing the first data unit including the at least one second data unit(s) and the uplink information for the scheduling control if the first data unit has the room for adding the uplink information for the scheduling control.

Preferably, the method further includes the step of transmitting the provided first data unit through an enhanced dedicated channel (E-DCH) to a network.

Preferably, the method further includes the step of receiving a grant signal from the network.

To further achieve these and other advantages and in accordance with the purpose of the present invention, a method of transmitting control information for scheduling in a communication system comprises the step of receiving at least one of a first identifier and a second identifier for an enhanced-dedicated channel (E-DCH) from a base station and determining whether to transmit control information for a radio resource request based on a type of the received identifier.

Preferably, the method further includes the step of determining not to transmit the control information for the radio resource request if the received identifier is the second identifier.

To further achieve these and other advantages and in accordance with the purpose of the present invention, a method of transmitting control information for scheduling in a communication system comprises the steps of receiving a first identifier and a second identifier for an enhanced-dedicated channel (E-DCH) from a base station, receiving transmission condition parameters corresponding to the first identifier and the second identifier, respectively, and transmitting control information for a radio resource request according to the transmission condition.

To further achieve these and other advantages and in accordance with the purpose of the present invention, a method of transmitting control information for scheduling in a communication system comprises the steps of receiving a first identifier and a second identifier for an enhanced-dedicated channel (E-DCH) from a base station, receiving a transmission condition parameter corresponding to the first identifier and the second identifier, receiving ratio information for transmitting control information for a radio resource request according to the transmission condition, and transmitting the control information for the radio resource request according to the condition and the ratio information.

To further achieve these and other advantages and in accordance with the purpose of the present invention, a method of transmitting control information for scheduling in a communication system comprises the steps of receiving at least one of a first identifier and a second identifier for an enhanced-dedicated channel (E-DCH) from a base station and receiving information indicating whether to transmit control information for a radio resource request to the base station.

To further achieve these and other advantages and in accordance with the purpose of the present invention, a method of transmitting control information for scheduling at a layer of a mobile terminal in a communication system comprises the steps of receiving at least one upper layer data unit from an upper layer, configuring a lower layer data unit by including the at least one upper layer data unit, a header providing control information associated with the at least one upper layer data unit, and scheduling information providing radio resource allocation request information into the lower layer data unit, and transferring the lower layer data unit to a lower layer.

To further achieve these and other advantages and in accordance with the purpose of the present invention, a method of transmitting control information for scheduling at a mobile terminal in a communication system comprises the steps of checking whether a condition for transmitting scheduling information providing radio resource allocation request information is satisfied, and transmitting a first lower layer data unit to a network side when the condition is satisfied, the first lower layer data unit including at least one upper layer data unit delivered from an upper layer, a header providing control information associated with the at least one upper layer data unit, and the scheduling information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a network structure of UMTS (universal mobile telecommunications system);

FIG. 2 is an architectural diagram of a radio interface protocol between UE and UTRAN (UMTS terrestrial radio access network); and

FIG. 3 is an architectural diagram of a protocol for DCH and E-DCH.

FIG. 4 is a diagram illustrating an example of a MAC-e PDU in accordance with a preferred embodiment according to the present invention.

FIG. 5 is a diagram illustrating a flowchart in accordance with a preferred embodiment of the present invention.

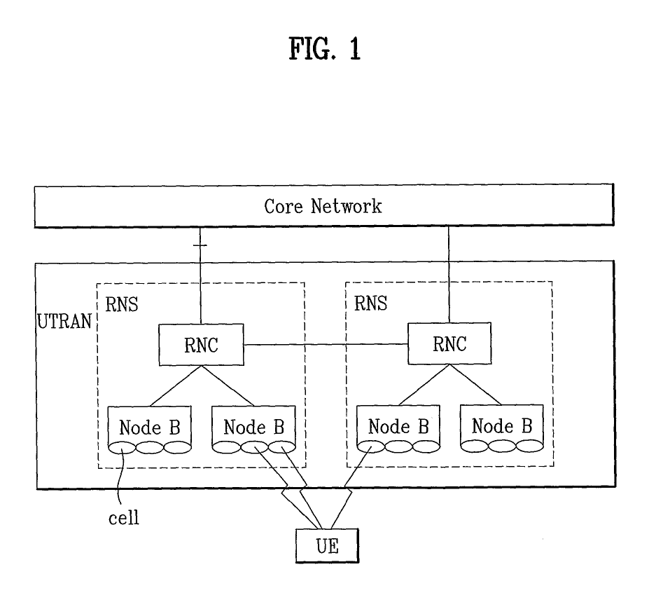

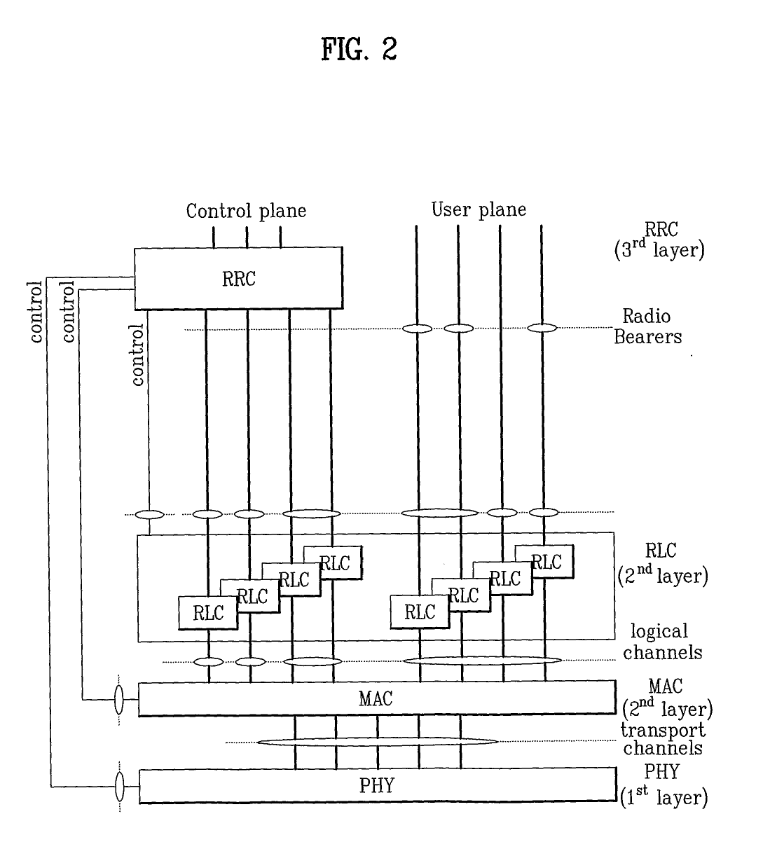

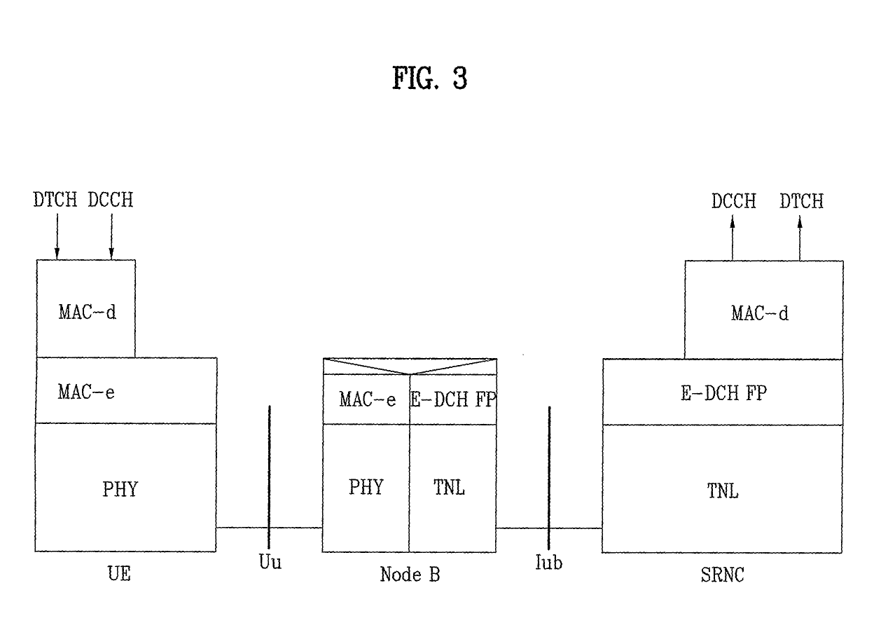

### BEST MODE FOR CARRYING OUT THE INVENTION

Reference will now be made in detail to the preferred embodiments of the present invention, examples of which are illustrated in the accompanying drawings.

A Node B has a scheduler for E-DCH. The scheduler plays a role in an optimal radio resource allocation to each UE existing within one cell to raise transmission efficiency of uplink data arriving at a base station from all UEs within each cell. In particular, more radio resource allocation is made to a UE having a good channel status in one cell to enable the corresponding UE to transmit more data. And, less radio resource allocation is made to a UE having a poor channel status. So, a signal transmitted by the UE is prevented from causing interference in uplink. Through this scheduling, a quantity of uplink data transmission of a whole cell can be optimized.

Yet, the scheduler does not consider a radio channel status of a UE only in making the radio resource allocation to the corresponding UE. The scheduler needs control information from UEs. For example, the control information includes a power quantity the UE can use for EDCH or a quantity of data the UE attempts to transmit. Namely, even if the UE lies in a better channel status, in case that there is no spare power the UE can use for E-DCH or if there is no data the UE will transmit in an uplink direction, a radio resource should not be allocated to the UE. In other words, the scheduler can efficiently operate radio resources by preferentially allocating a radio resource to a UE having a spare power for E-DCH and data to be transmitted in the uplink direction.

So, a UE should send control information to a scheduler of a Node B. And, this control information can be transmitted in various ways. For instance, a scheduler of a Node B can instruct a UE to make a report that data to be transmitted in uplink exceeds a prescribed value or to periodically send control information to the Node B itself. Meanwhile, the use is able to instruct the Node B to make a report of control information periodically. Thus, the information transmitted to the Node B by the UE to have the radio resource allocation is called radio resource allocation request information or scheduling information. And, a size of the radio resource allocation request information can be set to 18 bits. Preferably, the radio resource allocation request control information or the scheduling information includes at least one of mobile terminal buffer status information and mobile terminal power status information.

It may be necessary for the UE to transmit scheduling information. In this case, the UE transmits the MAC-e PDU containing user data and the scheduling information or the MAC-e PDU containing the scheduling information only without user data. In case that a length of bits for the execution of padding is greater than the size of scheduling information to be transmitted to the Node B, the UE transmits MAC-e PDU within which the scheduling information is included.

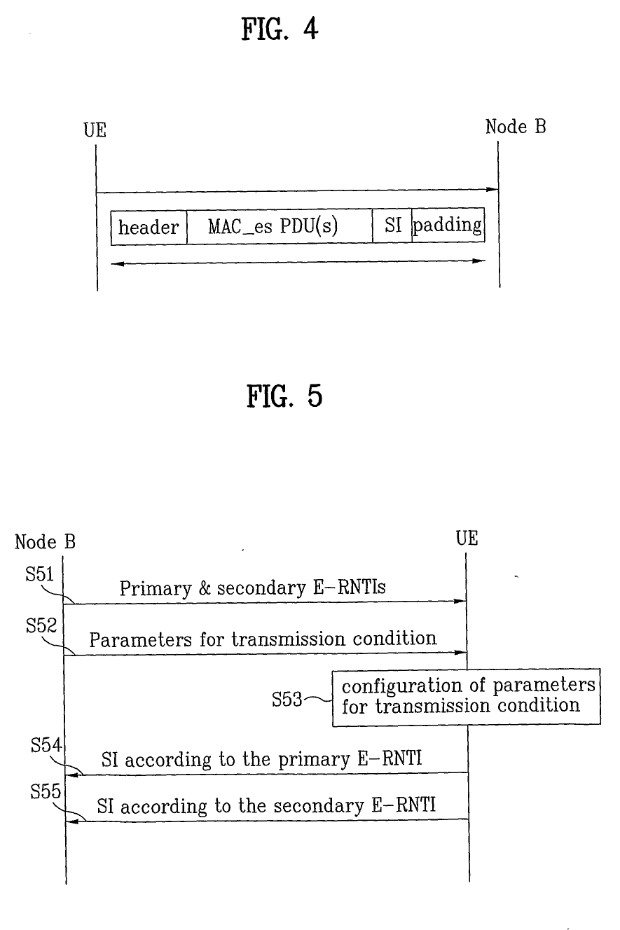

FIG. 4 is a diagram illustrating an example of a MAC-e PDU in accordance with a preferred embodiment according to the present invention.

Referring to FIG. 4, the MAC-e PDU comprises a header, at least one MAC-es PDU, scheduling information, and padding bits. The header includes control information associated with the at least one MAC-es PDU. The header may have a field indicating that the scheduling information is included in the MAC-e PDU.

If the scheduler of the Node B allocates a radio resource to the UE, the UE configures the MAC-e PDU with the allocated radio resource and then transmits the configured MAC-e PDU to the Node B via E-DCH.

In particular, in case that the UE has data to be transmitted to the Node B, the UE sends control information to the Node B to indicate that there is data to be sent by the UE itself. The scheduler of the Node B sends information indicating allocation of a radio resource to the UE based on the control information having been sent by the UE.

In this case, the information indicating the allocation of the radio resource can include a maximum of a power transmittable in uplink by the UE or a ratio for a reference channel. And, the UE configures MAC-e PDU within a permitted range based on the information indicating the allocation of the radio resource and then transmits the configured MAC-e PDU.

Meanwhile, a UTRAN may define a method or situation for sending scheduling information from a UE to control an uplink radio resource and then informs the UE of the defined method or situation.

For instance, the scheduling information is made to be periodically transmitted using a timer (Timer-based reporting) or to be transmitted in case of an occurrence of a specific event. In the periodically sending method, the scheduling information is sent each time the timer expires. And, the timer is initialized if the scheduling information is transmitted.

In the method of sending the scheduling information in case of the occurrence of the event, the UE sends the scheduling information each time a situation previously set up by the UTRAN occurs in the UE. For instance, if a quantity of data stacked on a buffer of the UE becomes greater or smaller than a specific value, the scheduling information is made to be transmitted.

Another aspect of the present invention proposes that a Node B should not set a timer-based reporting, an event-based reporting or the like for UEs having secondary E-RNTI only. In this case, each of the UEs does not know a reference for sending scheduling information, thereby not sending the scheduling information to the Node B.

In an embodiment of the the present invention, without any instruction from a Node B, a UE may not send scheduling information to a Node B in case of operating with a secondary E-RNTI. While operating with the secondary E-RNTI, in case of not performing a timer-based reporting or an event-based reporting or in case of performing the timer-based reporting or the event-based reporting the UE does not send the scheduling information to the Node B even if a situation that the scheduling information needs to be sent takes place.

Meanwhile, in case that a UE operates with both a primary E-RNTI and a secondary E-RNTI, a Node B sets a timer based reporting and an event-based reporting having different parameters, respectively.

For instance, a UE selects different parameters corresponding to a type of an E-RNTI with which the UE itself operates and then performs a timer based reporting or an event-based reporting. Accordingly, if a situation that scheduling information needs to be sent takes place, the UE sends the scheduling information.

Namely, a UE possessing both a primary E-RNTI and a secondary E-RNTI sets a timer-based reporting and an event-based reporting with parameters used in case of the operation with the primary E-RNTI and sets a timer-based reporting and an event-based reporting with parameters used in case of the operation with the secondary E-RNTI.

FIG. 5 is a diagram illustrating a flowchart in accordance with a preferred embodiment of the present invention.

A UE receives a primary E-RNTI and a secondary E-RNTI from a Node B [S51]. Preferably, the primary E-RNTI and a secondary E-RNTI is received during an initial call setup procedure. The UE receives parameters for transmission condition corresponding to the primary E-RNTI and the secondary E-RNTI, respectively from the Node B [S52]. Instead of receiving the parameters from the Node B, the UE may store predetermined parameters for transmission condition in its storage module. The UE configures the parameters for the transmission condition for determining whether a condition is satisfied for transmitting scheduling information to the Node B [S53]. Preferably, different parameters are applied to the primary E-RNTI and the secondary E-RNTI. For example, in case that the UE operates with the primary E-RNTI, once data of 50 KB is stored in a buffer, the UE sends scheduling information to a Node B. In case that a UE operates with a secondary E-RNTI, once data of 100 KB is stored in the buffer, the UE is made to send scheduling information to a Node B. The UE transmits scheduling information to the Node B when a transmission condition according to the primary E-RNTI is satisfied [S54]. The UE transmits scheduling information to the Node B when a transmission condition according to the secondary E-RNTI is satisfied [S55]. Preferably, the parameters for the transmission conditions are configured so that the scheduling information is transmitted in an active mode of the primary E-RNTI more frequently than in an active mode of the secondary E-RNTI.

As another embodiment of the present invention, even if both a primary E-RNTI and a secondary E-RNTI are allocated to a UE, a Node B transmits same parameters and additionally informs the UE of a control information transmission ratio. In this case, the UE, which is operating with the secondary E-RNTI, sets a timer-based reporting and an event-based reporting using the parameters transmitted from the Node B. Instead of sending the scheduling information each time despite an occurrence of a situation that scheduling information needs to be transmitted to the Node B, the UE uses a value N of the control information transmission ratio indicated by the Node B and then transmits the scheduling information after waiting for N occurrences of the scheduling information.

For instance, if ‘N’ is set to 4 and if scheduling information is generated by performing the timer-based reporting and the event-based reporting, the scheduling information is transmitted to the Node B once each four occurrences of the situations instead of sending the scheduling information every time. In particular, under this circumstance, even if first to third scheduling informations are generated, they are not transmitted. Instead, only if third scheduling information is generated, the scheduling information is sent to the Node B. By regarding scheduling information next to the occurrence of the fourth scheduling information as a first one, the above-explained process is repeated.

Meanwhile, in case that a situation that scheduling information needs to be sent takes place, only if a space (padding bit) remaining after filling MAC-e PDU with user data is able to include the scheduling information, a UE operating with secondary E-RNTI sends the scheduling information by including the scheduling information in the MAC-e PDU. Alternatively, the UE enables the scheduling information to be included in the MAC-e PDU regardless of a presence or non-presence of the situation that scheduling information needs to be sent only if the space to be filled with the scheduling information remains.

For instance, in case that a UE operates with a secondary E-RNTI, assuming that a size of a MAC-c PDU to be sent by the UE is 100 bits and that a size of user data to be included in the MAC-e PDU is 80 bits, a space remaining in the MAC-e PDU is enough to accommodate the scheduling information. Hence, the UE included the scheduling information in the MAC-e PDU and then sends it to a Node B.

According to another embodiment of the present invention, if a TTI of a UE is set to 10 ms, a Node B is able to inform the UE that a transmission of scheduling information is available using a bit indicating ‘one process’ or ‘all processes’ in filed of AG (absolute grant) in case of sending the AG to the UE.

For instance, under the situation that a TTI of a UE is set to 10 ms, if AG is sent to the UE by setting the bit of the AG to zero, the UE does not send scheduling information despite the occurrence of a situation that the scheduling information needs to be sent. Meanwhile, if the Node B sends the AG by setting the field to 1, the UE sends the scheduling information if the situation that the scheduling information needs to be sent takes place.

Meanwhile, E-DPCCH can be used in informing a Node B of a quantity of data existing in a buffer of a UE or whether there exists a power that can be additionally used by the UE.

For instance, one bit (hereinafter called ‘UE situation bit’) within E-DPCCH. In case of using 1 bit only, it is able to transmit whether data to be transmitted is accumulated in the UE over a predetermined reference.

Meanwhile, in case that the UE situation bit is used in informing a remaining power status, it is able to indicate whether a power greater than a radio resource allocation quantity set for the UE itself is usable for E-DCH.

In case that a UE informs a Node B of its situation using a UE situation bit within E-PDCCH in transmitting a MAC-e PDU on E-DPDCH, a remaining power status and a buffer status can be alternately indicated using the UE situation bit.

For instance, if a UE situation bit is used in indicating a remaining power status of a UE at a specific TTI, the UE situation bit is used in indication a buffer status of the UE at a next usable TTI. And, the UE situation bit can be used in indicating a remaining power status of the UE again at a subsequent TTI.

In order to effectively use a radio resource and to enable a UE to transmit scheduling information to a Node B, the UE can be made not to transmit the scheduling information for a process in an inactive mode. In this case, the Node B is set in a manner that the UE does not send MAC-e PDU for a specific process, whereby utilization of a radio resource of a cell managed by the Node B can be enhanced. If the UE does not even send the scheduling information for the inactive process, the Node B needs not to receive both E-DPCCH and E-DPDCH from the UE for the corresponding inactive process, whereby utilization and usefulness of Node B hardware can be enhanced.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention is applicable to a wireless communication system such as a broadband wireless access system, a mobile access system, and a mobile communications system, etc.

What is claimed is:

1. A method of transmitting control information for scheduling in a communication system, comprising the steps of:
filling a first data unit with at least one second data unit transmitted from an upper layer;
providing the first data unit including the at least one second data unit and uplink information for scheduling control if the first data unit has a room for adding the uplink information for the scheduling control.

2. The method of claim 1, wherein the uplink information for the scheduling control is scheduling information (SI).

3. The method of claim 1, wherein the uplink information for the scheduling control includes at least one of mobile terminal buffer status information and mobile terminal power status information.

4. The method of claim 3, wherein the mobile terminal has at least one of a primary radio network temporary identity (RNTI) and a secondary radio network temporary identity (RNTI).

5. The method of claim 1, further comprising the step of transmitting the provided first data unit through an enhanced dedicated channel (E-DCH) to a network.

6. The method of claim 5, further comprising the step of receiving a grant signal from the network.

7. The method of claim 6, wherein the grant signal corresponds to one of an absolute grant and a relative grant.

8. A method of transmitting control information for scheduling in a communication system, comprising the step of:
receiving at least one of a first identifier and a second identifier for an enhanced-dedicated channel (E-DCH) from a base station; and
determining whether to transmit control information for a radio resource request based on a type of the received identifier.

9. The method of claim 8, wherein the first identifier is allocated to a mobile terminal in a cell.

10. The method of claim 9, wherein the first identifier is a primary E-RNTI.

11. The method of claim 9, wherein the second identifier is allocated to a mobile station group in a cell.

12. The method of claim 11, wherein the second identifier is a secondary E-RNTI.

13. The method of claim 8, further comprising the step of determining not to transmit the control information for the radio resource request, if the received identifier is the second identifier.

14. A method of transmitting control information for scheduling in a communication system, comprising the steps of:
receiving a first identifier and a second identifier for an enhanced-dedicated channel (E-DCH) from a base station;
receiving transmission condition parameters corresponding to the first identifier and the second identifier, respectively; and
transmitting control information for a radio resource request according to the transmission condition.

15. The method of claim 14, wherein the first identifier is a primary E-RNTI and wherein the second identifier is a secondary E-RNTI.

16. The method of claim 15, wherein the control information for the radio resource request is transmitted in an active mode of the primary E-RNTI more frequently than in an active mode of the secondary E-RNTI.

17. The method of claim 14, wherein the transmission condition is applied to one of a timer-based reporting and an event-based reporting.

18. A method of transmitting control information for scheduling in a communication system, comprising the steps of:
receiving a first identifier and a second identifier for an enhanced-dedicated channel (E-DCH) from a base station;
receiving a transmission condition parameter corresponding to the first identifier and the second identifier;
receiving ratio information for transmitting control information for a radio resource request according to the transmission condition; and
transmitting the control information for the radio resource request according to the condition and the ratio information.

19. The method of claim 18, wherein the first identifier is a primary E-RNTI and wherein the second identifier is a secondary E-RNTI.

20. A method of transmitting control information for scheduling in a communication system, comprising the steps of:
receiving at least one of a first identifier and a second identifier for an enhanced-dedicated channel (E-DCH) from a base station; and
receiving information indicating whether to transmit control information for a radio resource request to the base station.

21. The method of claim 20, wherein the first identifier is a primary E-RNTI and wherein the second identifier is a secondary E-RNTI.

22. The method of claim 21, wherein the information is received via a bit included in an absolute grant.

23. The method of claim 21, wherein the information is received via a state variable of MAC-e/es.

24. The method of claim 23, wherein the state variable is SI_Trigger_Prohibit.

25. The method of claim 24, further comprising the step of omitting transmission of control information for a radio resource request if the value of the SI_Trigger_Prohibit represents true.

26. The method of claim 24, wherein the value of the SI_Trigger_Prohibit is initialized into ‘false’ if a mobile terminal has the primary E-RNTI.

27. The method of claim 24, wherein the value of the SI_Trigger_Prohibit is initialized into ‘true’ if a mobile terminal does not have the primary E-RNTI.

28. A method of transmitting control information for scheduling at a layer of a mobile terminal in a communication system, comprising the steps of:
receiving at least one upper layer data unit from an upper layer;
configuring a lower layer data unit by including the at least one upper layer data unit, a header providing control information associated with the at least one upper layer data unit, and scheduling information providing radio resource allocation request information into the lower layer data unit; and
transferring the lower layer data unit to a lower layer.

29. The method of claim 28, wherein the scheduling information is included in the lower layer data unit if the lower layer data unit has a room for the scheduling information.

30. The method of claim 28, wherein the upper layer data unit is a MAC-es PDU.

31. The method of claim 30, wherein the lower data unit is a MAC-e PDU.

32. A method of transmitting control information for scheduling at a mobile terminal in a communication system, comprising the steps of:
checking whether a condition for transmitting scheduling information providing radio resource allocation request information is satisfied; and
transmitting a first lower layer data unit to a network side when the condition is satisfied, the first lower layer data unit including at least one upper layer data unit delivered from an upper layer, a header providing control information associated with the at least one upper layer data unit, and the scheduling information.

33. The method of claim 32, further comprising:
including scheduling information into a second lower layer data unit if the second lower layer data unit has a room for the scheduling information; and
transmitting the second lower layer data unit to the network side.

34. The method of claim 33, wherein the second lower layer is transmitted to the network side although the condition is not satisfied.

35. The method of claim 32, wherein the condition is satisfied when a predetermined period is elapsed.

36. The method of claim 32, wherein the condition is satisfied when an event occurs.
